(19) United States
(12) Patent Application Publication
(10) Pub. No.: US 2024/0343328 A1
(43) Pub. Date: Oct. 17, 2024

(54) SYSTEM AND METHOD FOR PROJECTING DEFECT INFORMATION ON SURFACE OF VEHICLE BODY

(71) Applicants: Hyundai Motor Company, Seoul (KR); Kia Corporation, Seoul (KR)

(72) Inventor: Tae-Ho Kim, Seoul (KR)

(21) Appl. No.: 18/389,495

(22) Filed: Nov. 14, 2023

(30) Foreign Application Priority Data
Apr. 12, 2023 (KR) 10-2023-0048050

(51) Int. Cl. B62D 65/00

(52) U.S. Cl. CPC B62D 65/005

(57) ABSTRACT

A system for tracking a moving vehicle body applies a dynamic projection mapping technique utilizing a high-speed projector. The system includes a tracker configured to track a vehicle body of a vehicle to generate vehicle body position information, a quality inspector configured to generate surface quality information of the vehicle, a matcher configured to generate mapping information in which the vehicle body position information and the surface quality information are mapped, and an indicator configured to display the mapping information on a surface of the vehicle body of the vehicle.

### CROSS-REFERENCE TO RELATED APPLICATION(S)

This application claims under 35 U.S.C. § 119 (a) the benefit of Korean Patent Application No. 10-2023-0048050, filed on Apr. 12, 2023, the entire contents of which are incorporated herein by reference.

### BACKGROUND

### (a) Technical Field

The present disclosure relates to a technique for identifying vehicle body defect information, more particularly, to a system and method for projecting vehicle body surface quality defect information provided from a vision inspection process onto a vehicle body surface at high speed to allow an operator to intuitively identify a defect portion of a vehicle body.

### (b) Description of the Related Art

Generally, various panels of a vehicle such as a roof, a hood, doors, a trunk lid, and the like are attached to a vehicle body of the vehicle to form an exterior of the vehicle body. Defect portions such as irregularities, flection, cracks, scratches, and the like should not be formed on the exterior of the vehicle body. To this end, according to the related art, exterior inspection of the vehicle body is performed with only visual confirmation by an operator.

As described above, since a visual inspection method of the operator relies on a quality determination criteria according to capability of the operator and/or a work method of the operator, it is not possible to accurately inspect whether defect portions are present on the exterior of the vehicle body. Thus, there is a problem in that reliability of a vehicle subject to the visual inspection method may be degraded and uniform quality control of the vehicle body is difficult to achieve.

In order to solve the above problem, a technique for quantitatively and visually analyzing a surface defect of the vehicle body through a vision inspection method using patterned lighting has been proposed. In the technique, the result of the vehicle body surface quality vision inspection is displayed on a large monitor in the process. Therefore, the operator is required to visually check a defect position and identify a defect portion of the vehicle body surface.

Consequently, there is a problem in that it is likely that an operator will mis-identify a defect position on the vehicle body and/or workability may be degraded due to non-intuitiveness of the visual check performed by the operator.

### SUMMARY

An embodiment of the present disclosure is directed to providing a system and method for tracking a moving vehicle body by applying a dynamic projection mapping technique utilizing a high-speed projector.

Another embodiment of the present disclosure is directed to providing a system and method for projecting vehicle body surface quality defect information provided from a vision inspection process onto a vehicle body surface at high speed to allow an operator to intuitively identify a defect portion of a vehicle body.

Other objects and advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

In one aspect, a defect information projection system is provided that suitably comprises a) a quality inspector configured to generate surface quality information of a vehicle; b) a tracker configured to track a vehicle body of the vehicle to generate vehicle body position information; c) a matcher configured to generate mapping information in which the vehicle body position information and the surface quality information are mapped; and d) an indicator configured to display the mapping information. In certain aspects, suitably the indicator is configured to display the mapping information on a surface of the vehicle body of the vehicle.

In accordance with an embodiment of the present disclosure, there is provided a system for tracking a moving vehicle body by applying a dynamic projection mapping technique utilizing a high-speed projector.

The system may include a quality inspector configured to generate surface quality information of a vehicle, a tracker configured to track a vehicle body of the vehicle to generate vehicle body position information, a matcher configured to generate mapping information in which the vehicle body position information and the surface quality information are mapped, and an indicator configured to display the mapping information on a surface of the vehicle body of the vehicle.

In addition, the matcher may include a collection module configured to collect the vehicle body position information and the surface quality information, a mapping module configured to generate the mapping information by mapping the vehicle body position information and the surface quality information, and a conversion module configured to generate a projection content using the mapping information.

In addition, the projection content may be represented by projection coordinates.

In addition, the projection content may include defect extent information indicating a defect extent.

In addition, the defect extent may be classified into a major defect and a minor defect, and the major defect and the minor defect may be represented by at least one of a color, a size, or a shape in order to improve visibility.

In addition, the matcher may include a monitoring module configured to generate a virtual space represented by a unified coordinate system and monitor the vehicle, the tracker, and the indicator in the virtual space.

In addition, the system may further include a process controller configured to generate vehicle body entry information indicating a status of the vehicle entering a repair process line and vehicle body exit information indicating a status of the vehicle exiting from the repair process line.

In addition, the surface quality information may include surface defect position information indicating a defect position at which a surface defect occurs and determination result information indicating whether a defect occurs at the defect position.

In addition, the surface quality information may include vehicle type information of the vehicle.

In addition, the vehicle body position information may be feature point information on feature points extracted from the vehicle body of the vehicle.

In addition, the matcher may generate vehicle body shape information of the vehicle for recognizing a shape of the vehicle body of the vehicle by matching the feature point information and modeling data of the vehicle in order to distinguish a vehicle type of the vehicle.

In addition, the indicator may be provided as a plurality of indicators in order to display the surface quality information, which is 3D information, on the surface of the vehicle body.

In accordance with another embodiment of the present disclosure, there is provided a (e.g., non-contact type) defect information projection method including generating, by a quality inspector, surface quality information of a vehicle, tracking, by a tracker, a vehicle body of the vehicle to generate vehicle body position information, generating, by a matcher, mapping information in which the vehicle body position information and the surface quality information are mapped, and displaying, by an indicator, the mapping information on a surface of the vehicle body of the vehicle.

In this case, the generating of the mapping information may include collecting, by a collection module, the vehicle body position information and the surface quality information, generating, by a mapping module, the mapping information by mapping the vehicle body position information and the surface quality information, and generating, by a conversion module, a projection content using the mapping information.

In addition, the generating of the vehicle body position information may include generating, by a process controller, vehicle body entry information indicating a status of the vehicle entering a repair process line.

In addition, the operation of the displaying may include generating, by a process controller, vehicle body exit information indicating a status of the vehicle exiting from the repair process line.

In addition, the generating of the mapping information may include matching, by the matcher, feature point information and modeling data of the vehicle to generate vehicle body shape information on the vehicle, and comparing, by the matcher, the vehicle body shape information with preset vehicle type information to distinguish a vehicle type of the vehicle.

Meanwhile, the generating of the mapping information may include matching, by the matcher, feature point information and modeling data of the vehicle to generate vehicle body shape information on the vehicle, and comparing, by the matcher, the vehicle body shape information with preset vehicle type information to distinguish a vehicle type of the vehicle.

### BRIEF DESCRIPTION OF THE DRAWINGS

FIG. 1 is a configurational block diagram illustrating a defect information projection system according to one embodiment of the present disclosure.

FIG. 2 is a detailed configurational block diagram illustrating a matcher shown in FIG. 1.

FIG. 3 is a conceptual diagram illustrating a vehicle body surface quality inspection according to one embodiment of the present disclosure.

FIG. 4 is a conceptual diagram illustrating projection execution in the defect information projection system shown in FIG. 1.

FIG. 5 is a flowchart illustrating a process of verifying defect information according to one embodiment of the present disclosure.

FIG. 6 is a conceptual diagram illustrating vehicle body shape recognition according to one embodiment of the present disclosure.

FIG. 7 is a conceptual diagram illustrating vehicle body shape recognition according to another embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The above and other objectives, features, and advantages of the present disclosure will be described in detail with reference to the accompanying drawings, and therefore, the technical spirit of the present disclosure can be easily implemented by those skilled in the art to which the present disclosure pertains.

In the following description of the present disclosure, when a detailed description of the known related art is determined to obscure the gist of the present disclosure, the detailed description thereof will be omitted.

Hereinafter, exemplary embodiments of the present disclosure will be described in detail with reference to the accompanying drawings. In the drawings, the same reference numeral refers to the same or similar component.

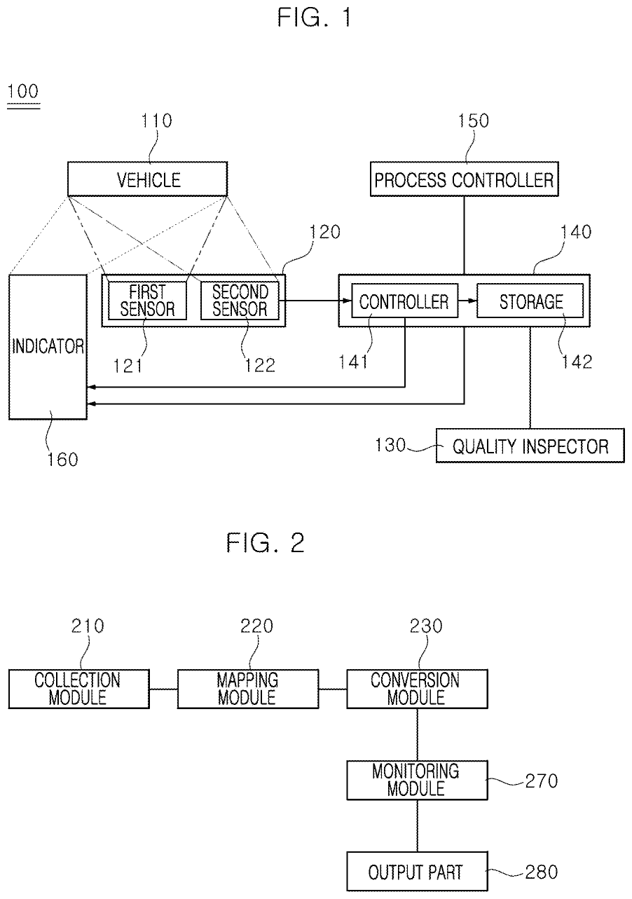

FIG. 1 is a configurational block diagram illustrating a (e.g., non-contact type) defect information projection system 100 according to one embodiment of the present disclosure. Referring to FIG. 1, the defect information projection system 100 may include a tracker 120 configured to track a vehicle body of a vehicle 110 to generate vehicle body position information, a quality inspector 130 configured to generate surface quality information of the vehicle 110, a matcher 140 configured to generate mapping information in which the vehicle body position information and the surface quality information are mapped, and an indicator 160 configured to display the mapping information on a surface of the vehicle 110.

The tracker 120 performs a function of tracking the vehicle body of the vehicle 110 when is being moved and obtaining the position information. To this end, the tracker 120 may include a first sensor 121 configured to emit light to the vehicle 110, and a second sensor 122 configured to detect a movement of the vehicle 110 through a video. Of course, the first sensor 121 and/or the second sensor 122 may be provided as a plurality of first sensors 121 and/or a plurality of second sensors 122 so as to generate three-dimensional (3D) position information on the vehicle 110.

For example, pairs of the first sensors 121 and the second sensors 122 may be disposed at vertical positions/lateral positions/front and rear positions of the vehicle 110. Alternatively, as another example, a pair of the first sensors 121 and the second sensors 122 is disposed above the vehicle 110, and similarly is disposed below the vehicle 110.

The first sensor 121 may be an infrared ray (IR) lighting sensor, and the second sensor 122 may be an IR detection sensor. IR typically refers to light having a wavelength range of about 700 nm to 1 mm, and is a general term for electromagnetic waves with wavelengths that are longer than a wavelength of red light and are shorter than a wavelength of a microwave.

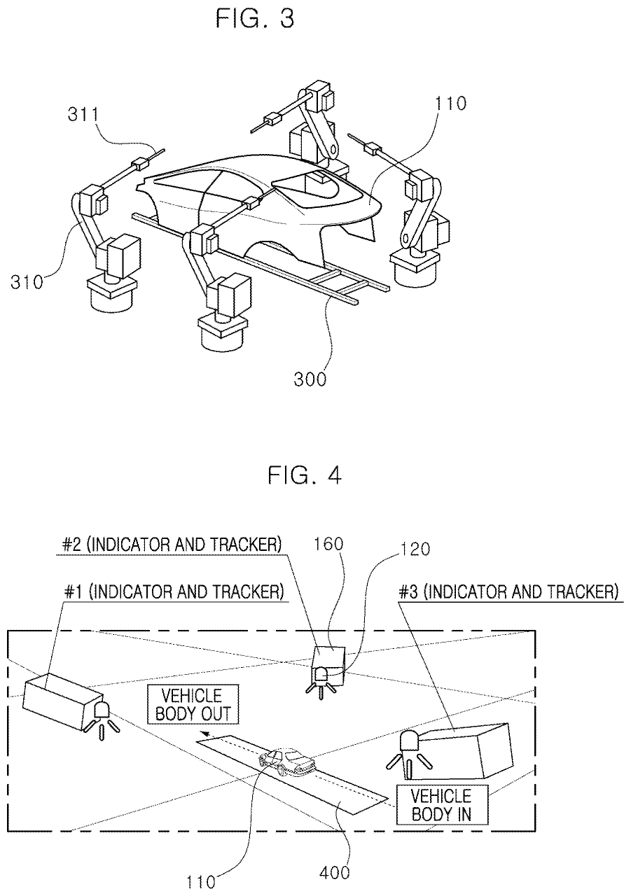

The quality inspector 130 performs a function of inspecting surface quality of the vehicle body of the vehicle 110 to generate quality information. In other words, the quality inspector 130 inspects a defect portion formed on the exterior of the vehicle body and generate the quality information. Examples of defects include irregularities, flection, cracks, scratches, and the like. An example of the quality inspection is shown in FIG. 3. The surface quality information generated by the quality inspector 130 is typically 3D information. FIG. 3 will be described in greater detail below.

Referring to FIG. 1, the matcher 140 performs a function of generating mapping information in which the vehicle body position information generated by the tracker 120 and the surface quality information from the quality inspector 130 are mapped. To this end, the matcher 140 may include a controller 141 configured to generate mapping information in which the position information of the vehicle body and the surface quality information are mapped, and a storage 142 configured to store the vehicle body location information, the surface quality information, and the mapping information.

The storage 142 may be a memory provided in the controller 141 or may be a separate memory. Thus, the storage 142 may include a non-volatile memory such as a solid state disk (SSD), a hard disk drive, a flash memory, an electrically erasable programmable read-only memory (EEPROM), a static random access memory (SRAM), a ferro-electric RAM (FRAM), a phase-change RAM (PRAM), or a magnetic RAM (MRAM) and/or a volatile memory such as a dynamic RAM (DRAM), a synchronous DRAM (SDRAM), or a double data rate-SDRAM (DDR-SDRAM), or a combination thereof.

A process controller 150 performs a function of generating vehicle body entry information or vehicle body exit information of the vehicle 110. To this end, the process controller 150 may include a programmable logic controller (PLC) or the like. In addition, the process controller 150 may be associated with a manufacturing execution system (MES) to use MES information. The MES information may include a vehicle type number, a commit number, a bogie number, and a vehicle identification number (VIN).

The indicator 160 performs a function of displaying the mapping information on the surface of the vehicle 110. In other words, the indicator 160 projects the quality information (i.e., the vehicle body surface quality defect information) provided from the vision inspection process according to the quality inspector 130 on a surface of the vehicle body at high speed. Thus, it is possible for an operator to intuitively and directly identify a defect portion of the vehicle body of the vehicle 110.

To this end, the indicator 160 may include a projector (not shown), a power supply (not shown) for supplying power to the projector, and a communication circuit (not shown) which connects the projector to the matcher 140. The projector may be a beam projector capable of beam projection.

The surface quality information generated by the quality inspector 130 is typically 3D information. Therefore, the indicator 160, which typically displays information corresponding to the 3D information on the surface of the vehicle body, is generally a projector to inevitably display the information according to 2D coordinate information. Therefore, coordinate values of the surface quality information are converted from 3D values into 2D values in consideration of position information of the projector. Thus, the indicator 160 may need to be installed as a plurality of indicators 160 to cover the entire are of the surface of the vehicle body. That is, in order to cover the entire 3D area using the 2D indicator 160, a plurality of projectors should be disposed.

FIG. 2 is a detailed configurational block diagram illustrating the matcher 140 shown in FIG. 1. Referring to FIG. 2, the matcher 140 may include a collection module 210 configured to collect the vehicle body position information and the surface quality information, a mapping module 220 configured to generate the mapping information by mapping the vehicle body position information and the surface quality information, and a conversion module 230 configured to generate a projection content using the mapping information.

In addition, the collection module 210 may acquire vehicle information and process information. The vehicle information may include vehicle type information. To this end, the collection module 210 may include a communication modem, a microprocessor, and a memory.

The mapping module 220 generates the mapping information by mapping the vehicle body position information and the surface quality information. That is, the mapping module 220 maps the corresponding surface quality information according to vehicle body position information. The surface quality information includes defect position information indicating where a surface defect occurs and determination result information indicating whether a defect occurs at a corresponding defect position. Of course, the surface quality information may include the vehicle type information.

The conversion module 230 performs a function of converting the mapping information into 2D projection coordinates to generate the projection content. In addition, the conversion module 230 performs a function of storing the projection content in the storage 142. The projection content may include defect extent information indicating a defect extent.

For example, the defect extent may be classified as a major defect or a minor defect. In this case, the major defect may be displayed on the vehicle body of the vehicle 110 by a red point, and the minor defect may be displayed by a blue point. In addition to these colors, it is possible to secure visibility for the operator with a variety of sizes and shapes.

In addition, the conversion module 230 updates the mapping information in real time to generate the projection content and provides the projection content to the indicator 160 which is connected through a communication modem (not shown). The real-time update may be performed about 200 times or more per second.

A monitoring module 270 performs a function of monitoring the vehicle 110, the plurality of trackers 120, and the plurality of indicators 160 in a unified coordinate space. In other words, the monitoring module 270 generates a virtual space represented by a coordinate system and performs monitoring in the virtual space by arranging the vehicle 110, the plurality of trackers 120, and the plurality of indicators 160 in the virtual space.

An output part 280 performs a function of visually outputting the virtual space. In addition, the output part 280 may output a data processing process in real time. Of course, the output part 280 may output a setting screen and a menu screen. To this end, the output part 280 may include a display and a sound system. The display may include a liquid crystal display (LCD), a light-emitting diode (LED) display, a plasma display panel (PDP), an organic LED (OLED) display, a touch screen, a cathode ray tube (CRT), a flexible display, a micro LED, and a mini LED. The touch screen may be used as an output part and an input part.

The mapping module 220, the conversion module 230, and the monitoring module 270, which are shown in FIG. 2, mean units which process at least one function or operation, and may be implemented in software and/or hardware. The hardware may be implemented with an application specific integrated circuit (ASIC) designed to perform the above functions, a digital signal processor (DSP), a programmable logic device (PLD), a field programmable gate array (FPGA), a processor, a microprocessor, another electronic unit, or a combination thereof.

Software implementation may include a software configuration component (element), an object-oriented software configuration component, a class configuration component and a work configuration component, a process, a function, an attribute, a procedure, a subroutine, a segment of a program code, a driver, firmware, a microcode, data, database, a data structure, a table, an array, and a variable. The software and the data may be stored in a memory and executed by a processor. The memory or the processor may employ various parts well known to those skilled in the art.

FIG. 3 is a conceptual diagram illustrating a vehicle body surface quality inspection according to one embodiment of the present disclosure. That is, FIG. 3 is a conceptual diagram illustrating that a vehicle body surface quality inspection is performed in an inspection process line. Generally, for a surface quality inspection, a conveyor 300 is configured, and process sections for many processes (e.g., a painting process and a panel attachment process) are present on the conveyor 300.

Typically, in the conveyor 300, a distance between processes ranges from about 4000 mm to 7000 mm, and a moving speed ranges from about 30 mm/s to 100 mm/s. A moving time between the processes is calculated by dividing the distance between the processes by the moving speed.

A robot 310 having a sensor head 311 may be installed at an end of each process section. Of course, the sensor head 311 may be equipped with a plurality of sensors, and these sensors may be connected to the quality inspector 130 through communication. The communication may be wired communication or wireless communication.

The wired communication may include RS232, RS485, Modbus, control & communication (CC)-Link communication, or Ethernet communication. Meanwhile, the wireless communication may include infrared data (IrDA) communication, a local area network, ZigBee, Bluetooth, light fidelity (LiFi), wireless fidelity (WiFi), or near field control (NFC).

The quality inspector 130 may include a microcomputer, a microprocessor, and a memory. Therefore, the quality inspector 130 generates the quality information by irradiating a pattern image to the vehicle body, capturing the irradiated pattern as a video, comparing the captured pattern with a reference pattern, and determining a defect portion formed on the vehicle body. The memory may store software with an algorithm for generating the quality information, and data.

FIG. 4 is a conceptual diagram illustrating projection execution in the defect information projection system 100 shown in FIG. 1. Referring to FIG. 4, the vehicle 110 is moved on a conveyor 400. Of course, when the vehicle 110 is moved on the conveyor 400, the tracker 120 for tracking the movement of the vehicle 110 in corresponding sections #1 to #3 whenever the vehicle 110 is moved and the indicator 160 for displaying the projection content on the surface of the vehicle 110 are provided.

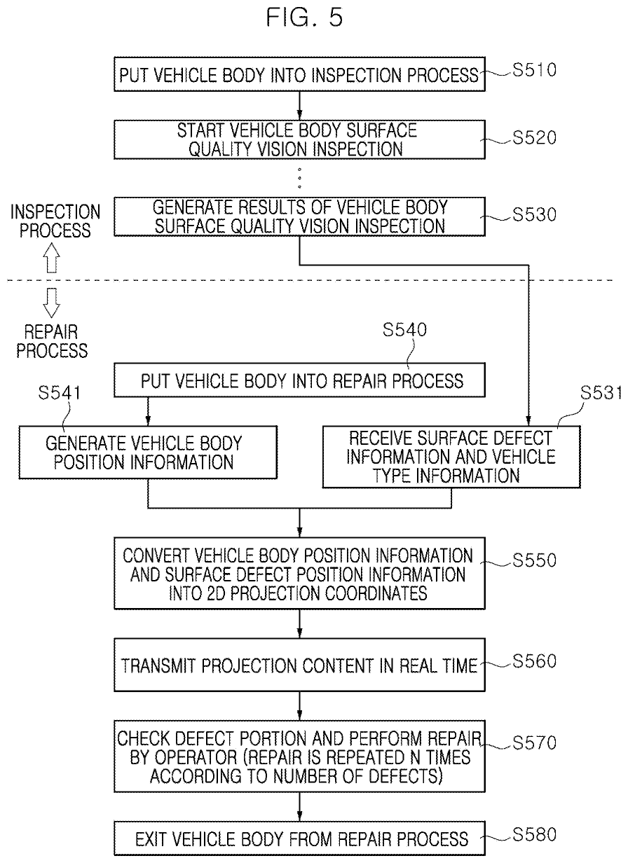

FIG. 5 is a flowchart illustrating a process of verifying defect information according to one embodiment of the present disclosure. Referring to FIG. 5, when the vehicle body of the vehicle 110 is put into an inspection process (i.e., the inspection process line), a vehicle body surface quality vision inspection starts (S510 and S520). As the vehicle body surface quality vision inspection is performed, results of the vehicle body surface quality vision inspection are generated, and the results are transmitted to the matcher 140 as surface quality information (S530).

The surface quality information includes surface defect position information indicating a defect position at which a surface defect occurs and determination result information indicating whether a defect occurs at the defect position. The surface defect position information may be represented in 3D and, alternatively, may be represented in 2D. The surface quality information may include vehicle type information.

Subsequently, when the vehicle body of the vehicle 110 is put into a repair process (i.e., a repair process line), the matcher 140 generates vehicle body position information on the vehicle 110 which is being moved in the line and receives the surface defect information and vehicle type information from the quality inspector 130 (S531, S540, and S541).

Then, the matcher 140 maps the vehicle body position information and the surface defect position information, converts the mapping information into projection coordinates, and generates a projection content to be projected on the surface of the vehicle body of the vehicle 110 (S550). Of course, the projection content may be updated in real time.

The projection content is then transmitted from the matcher 140 to the indicator 160 to be projected onto the surface of the vehicle body (S560). In other words, the projection content and the surface of the vehicle body are mapped so that points may be displayed on the surface of the vehicle body.

The operator then checks the defect portion and performs the repair (S570). The repair may be repeated N times according to the number of defects, and a corresponding repair process is terminated as the corresponding section is changed.

Thereafter, when all repair operations are terminated, the repair process is terminated and the vehicle 110 exits from the repair process line (S580).

The operations illustrated in FIG. 5 are for illustrative purposes only, and in some cases, the order of the operations may be changed or the operations may be combined.

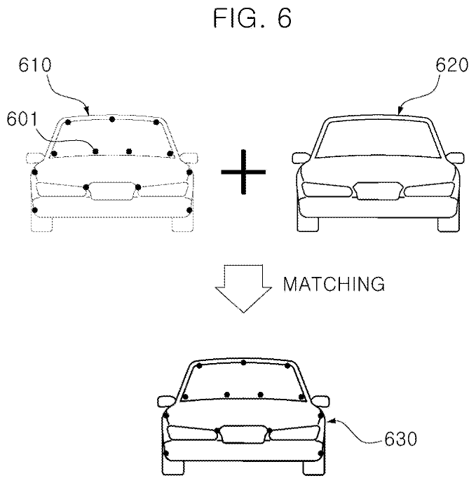

FIG. 6 is a conceptual diagram illustrating vehicle body shape recognition according to one embodiment of the present disclosure. Referring to FIG. 6, major feature points 601 for the vehicle body of the vehicle 110 are extracted using the tracker 120 to generate feature point information (610). The feature point information is the vehicle body location information which is transmitted to the matcher 140 by the tracker 120.

The feature points 601 may be end portions of outer peripheries of vehicle parts and grooves on the surface of the vehicle body. The vehicle parts may include a roof, a hood, doors, and a trunk lid which mainly form the exterior. Of course, these feature points 601 may be stored in a database organized in advance for each vehicle type and each part assembled in the vehicle, and the extracted feature points and pre-stored feature points may be represented by coordinate information.

In addition, design data is used to generate 3D modeling data of the vehicle body (620). Of course, the 3D modeling data of the vehicle body may be generated in advance.

The matcher 140 matches the feature point information and the 3D modeling data, recognizes a final shape of the vehicle body, and generates vehicle body shape information (630). That is, in order to distinguish a vehicle type of the vehicle 110, the vehicle body shape information and the vehicle type information, which is preset and stored, are compared. Of course, the vehicle type information may be received from the quality inspector 130 and the process controller 150.

The first sensor 121 and the second sensor 122 included in the tracker 120 are capable of transmitting and receiving infrared light to extract major feature points of the vehicle body. In addition, in order to improve accuracy of the shape of the vehicle body, the shape of the vehicle body is recognized in combination with the 3D modeling data of the vehicle body. In other words, by comparing the vehicle body shape information with the preset vehicle type information, it is possible to distinguish the vehicle type of the current vehicle 110.

In addition, it is possible to implement a high resolution using sensor performance, a sensor type, and a fusion sensor. In addition, it may be advantageous for extracting the feature points through the high resolution.

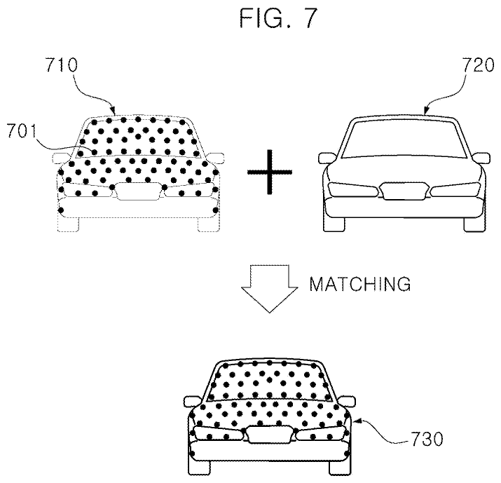

FIG. 7 is a conceptual diagram illustrating vehicle body shape recognition according to another embodiment of the present disclosure. Referring to FIG. 7, major feature points 701 for the vehicle body of the vehicle 110 are extracted using the tracker 120 to generate feature point information (710). The feature point information is the vehicle body location information which is transmitted to the matcher 140 by the tracker 120.

The matcher 140 generates 3D modeling data of the vehicle body (720) using design data. Of course, the 3D modeling data of the vehicle body may be generated in advance and stored in the matcher 140.

The matcher 140 matches the feature point information and the 3D modeling data, recognizes a final shape of the vehicle body, and generates vehicle body shape information (730). In FIG. 7, the tracker 120 may be a light detection and ranging (LiDAR). LiDAR may repeat transmission and reception of light millions of times per second to form a real-time 3D map and recognize the shape of the vehicle body by combining the real-time 3D map with the 3D modeling data of the vehicle body so as to improve accuracy of the shape of the vehicle body.

In other words, by comparing the vehicle body shape information with the preset vehicle type information, it is possible to distinguish the vehicle type of the current vehicle 110. The vehicle type information may be stored in the matcher 140 in advance or may be received from the quality inspector 130 and/or the process controller 150.

In addition, the operations of the method or algorithm described in connection with the embodiments disclosed herein may be implemented in the form of a program command which is executable through various computer means, such as a microprocessor, a processor, a central processing unit (CPU), and the like, and may be recorded in a computer-readable medium. The computer-readable medium may include program (command) codes, data files, data structures, and the like in alone or a combination thereof.

In accordance with the present disclosure, since an operator can intuitively distinguish a defect portion of a vehicle body, a time for recognizing defect information can be reduced. That is, the defect portion can be intuitively checked within about one second through projection mapping on a surface of the vehicle body.

In addition, another effect of the present disclosure is that defect information can be objectively verified without the need for operator intervention so that a probability of mis-determination on the defect portion can be reduced.

Further, still another effect of the present disclosure is that a repair operation is performed only on a projection mapped defect so that workability can be improved.

While the present disclosure has been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

What is claimed is:

1. A defect information projection system, comprising:
a quality inspector configured to generate surface quality information of a vehicle;
a tracker configured to track a vehicle body of the vehicle to generate vehicle body position information;
a matcher configured to generate mapping information in which the vehicle body position information and the surface quality information are mapped; and
an indicator configured to display the mapping information.

2. The defect information projection system of claim 1 wherein the indicator is configured to display the mapping information on a surface of the vehicle body of the vehicle.

3. The defect information projection system of claim 1, wherein the matcher includes:
a collection module configured to collect the vehicle body position information and the surface quality information;
a mapping module configured to generate the mapping information by mapping the vehicle body position information and the surface quality information; and
a conversion module configured to generate a projection content using the mapping information.

4. The defect information projection system of claim 3, wherein the projection content is represented by projection coordinates.

5. The defect information projection system of claim 3, wherein the projection content includes defect extent information indicating a defect extent.

6. The defect information projection system of claim 5, wherein the defect extent is classified into a major defect and a minor defect, and the major defect and the minor defect are represented by at least one of a color, a size, or a shape in order to improve visibility.

7. The defect information projection system of claim 3, wherein the matcher includes a monitoring module configured to generate a virtual space represented by a unified coordinate system and monitor the vehicle, the tracker, and the indicator in the virtual space.

8. The defect information projection system of claim 1, further comprising:
a process controller configured to generate vehicle body entry information indicating a status of the vehicle entering a repair process line and vehicle body exit information indicating a status of the vehicle exiting from the repair process line.

9. The defect information projection system of claim 1, wherein the surface quality information includes surface defect position information indicating a defect position at which a surface defect occurs and determination result information indicating whether a defect occurs at the defect position.

10. The defect information projection system of claim 1, wherein the surface quality information includes vehicle type information of the vehicle.

11. The defect information projection system of claim 1, wherein the vehicle body position information is feature point information on feature points extracted from the vehicle body of the vehicle.

12. The defect information projection system of claim 10, wherein the matcher generates vehicle body shape information of the vehicle for recognizing a shape of the vehicle body of the vehicle by matching the feature point information and modeling data of the vehicle in order to distinguish a vehicle type of the vehicle.

13. The defect information projection system of claim 1, wherein the indicator is provided as a plurality of indicators in order to display the surface quality information, which is 3D information, on the surface of the vehicle body.

14. A defect information projection method, comprising:
generating, by a quality inspector, surface quality information of a vehicle;
tracking, by a tracker, a vehicle body of the vehicle to generate vehicle body position information;
generating, by a matcher, mapping information in which the vehicle body position information and the surface quality information are mapped; and
displaying, by an indicator, the mapping information on a surface of the vehicle body of the vehicle.

15. The defect information projection method of claim 14, wherein the generating of the mapping information includes:
collecting, by a collection module, the vehicle body position information and the surface quality information;
generating, by a mapping module, the mapping information by mapping the vehicle body position information and the surface quality information; and
generating, by a conversion module, a projection content using the mapping information.

16. The defect information projection method of claim 14, wherein the generating of the vehicle body position information includes generating, by a process controller, vehicle body entry information indicating a status of the vehicle entering a repair process line.

17. The defect information projection method of claim 14, wherein the operation of the displaying includes generating, by a process controller, vehicle body exit information indicating a status of the vehicle exiting from the repair process line.

18. The defect information projection method of claim 14, wherein the vehicle body position information is feature point information on feature points extracted from the vehicle body of the vehicle.

19. The defect information projection method of claim 18, wherein the generating of the mapping information includes:
matching, by the matcher, feature point information and modeling data of the vehicle to generate vehicle body shape information on the vehicle; and
comparing, by the matcher, the vehicle body shape information with preset vehicle type information to distinguish a vehicle type of the vehicle.

20. The defect information projection method of claim 14, wherein the indicator is provided as a plurality of indicators in order to display the surface quality information, which is 3D information, on the surface of the vehicle body.
